(19) United States
(12) Patent Application Publication
(10) Pub. No.: US 2026/0091688 A1
(43) Pub. Date: Apr. 2, 2026

(54) DOUBLE-FED INDUCTION MOTORS FOR ALL-WHEEL DRIVE

(71) Applicant: Volvo Car Corporation, Göteborg (SE)

(72) Inventors: Aditya Pratap Singh, Gothenburg (SE); Jonas Forssell, Torslanda (SE)

(73) Assignee: Volvo Car Corporation, Göteborg (SE)

(21) Appl. No.: 18/898,870

(22) Filed: Sep. 27, 2024

(51) Int. Cl. B60L 15/20; B60L 15/00

(52) U.S. Cl. CPC B60L 15/20; B60L 15/007; B60L 2210/44; B60L 2220/12; B60L 2220/14; B60L 2220/42

(57) ABSTRACT

A system is described. The system comprises: a double-fed induction machine (DFIM) coupled to a first axle drive; a first electric machine coupled to a second axle drive; a power supply that supplies a first power to the first electric machine; and a controller. The controller provides the first power to a stator of the DFIM; converts the first power to a second power through a converter based on a message from a sensor module; and supplies the second power to a rotor of the DFIM. In an embodiment, supplying the first power to the first electric machine obtains a first speed and a first torque from the first electric machine on the second axle drive; and supplying the first power and the second power to the stator and the rotor respectively obtains a second speed and a second torque from the DFIM on the first axle drive.

### FIELD OF THE INVENTION

The present disclosure relates generally to a power system. More specifically, the present disclosure relates to a power system having a double-fed induction motor to achieve a simpler circuit design for all-wheel drive (AWD) applications.

### BACKGROUND

Battery Electric Vehicles (BEV) generally use independent inverters on front axle drive and rear axle drive for the All-Wheel-Drive (AWD) application. In conventional BEV, an inverter is required to convert direct current (DC) output from the battery to alternating current (AC) output for the input to electric machines. Hence, the conventional AWD setups always require two inverters for AWD, one for each axle to have independent speed and torque for both axles. The two inverters demand high cost, space, and weight problems.

Therefore, there is a long-felt need for a power system with a simpler circuit design in all-wheel drive (AWD) application to achieve independent speed and independent torque on both axles.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, methods, and/or apparatus are presented that describes a power system that employs double-fed induction machine (DFIM) to eliminate need of independent inverters on front axle drive and rear axle drive for All-Wheel-Drive (AWD) application.

In an aspect, a system is described. The system comprises: a double-fed induction machine (DFIM) coupled to a first axle drive; a first electric machine coupled to a second axle drive; a power supply that supplies a first power to the first electric machine; and a controller. The controller is configured to receive the first power from the power supply and provides the first power to a stator terminal of the double-fed induction machine (DFIM), convert the first power to a second power through a back-to-back converter based on a message received from a sensor module, and supply the second power to a rotor terminal of the double-fed induction machine (DFIM).

In another aspect, a method is described. The method comprises: supplying a first power from a power supply to a first electric machine; receiving the first power from the power supply and providing to a stator terminal of a double-fed induction machine (DFIM); converting the first power to a second power through a back-to-back converter based on a message received from a sensor module; and supplying the second power to a rotor terminal of the double-fed induction machine (DFIM).

In another aspect, a non-transitory computer readable storage medium is described. The non-transitory computer readable storage medium comprises a sequence of instructions, which when executed by a processor causes: supplying a first power from a power supply to a first electric machine; receiving the first power from the power supply and providing to a stator terminal of a double-fed induction machine (DFIM); converting the first power to a second power through a back-to-back converter based on a message received from a sensor module; and supplying the second power to a rotor terminal of the double-fed induction machine (DFIM).

In another aspect, a system is described. The system comprises: a double-fed induction machine (DFIM) coupled to a first axle drive; a first electric machine coupled to a second axle drive; a power supply that supplies a first power to the first electric machine; and a controller. The controller is configured to receive the first power from the power supply and provides the first power to a stator terminal of the double-fed induction machine (DFIM); receive a direct current (DC) from the power supply; convert the direct current (DC) to a second power through a converter; and supply the second power to a rotor terminal of the double-fed induction machine (DFIM).

In another aspect, a method is described. The method comprises: supplying a first power from a power supply to a first electric machine; receiving the first power from the power supply and provides the first power to a stator terminal of a double-fed induction machine (DFIM); receiving a direct current (DC) from the power supply; converting the direct current (DC) to a second power through a converter; and supplying the second power to a rotor terminal of the double-fed induction machine (DFIM).

In another aspect, a non-transitory computer readable storage medium is described. The non-transitory computer readable storage medium comprising a sequence of instructions, which when executed by a processor causes: supplying a first power from a power supply to a first electric machine; receiving the first power from the power supply and provides the first power to a stator terminal of a double-fed induction machine (DFIM); receiving a direct current (DC) from the power supply; converting the direct current (DC) to a second power through a converter; and supplying the second power to a rotor terminal of the double-fed induction machine (DFIM).

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a power system having a simpler circuit design for all-wheel drive (AWD) application, according to one or more embodiments.

FIG. 2 illustrates a power system having a simpler circuit design for all-wheel drive (AWD) application, according to one or more embodiments.

FIG. 3 illustrates a method, according to one or more embodiments.

FIG. 4 illustrates a non-transitory computer readable storage medium, according to one or more embodiments.

FIG. 5 illustrates a power system having a simpler circuit design for all-wheel drive (AWD) application, according to one or more embodiments.

FIG. 6 illustrates a method, according to one or more embodiments.

FIG. 7 illustrates a non-transitory computer readable storage medium, according to one or more embodiments.

FIG. 8 illustrates a message sent by the sensor module to the controller, according to one or more embodiments.

FIG. 9 illustrates a schematic diagram of a controller, according to one or more embodiments.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more. ” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately”can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

Embodiments may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

The following terms and phrases, unless otherwise indicated, shall have the following meanings.

As used herein, the term “sensor module” refers to a unit that contains components or circuits in addition to the sensors. The additional components or circuits make the sensors easy to use. The sensor module may be an integrated circuit comprising additional components and sensors adaptable for an application. The sensor module comprises at least one of cameras, ultrasonic sensors, proximity sensors, accelerometers, gyroscopes, RADAR, LIDAR, etc. The sensor module may operate to monitor road surface conditions. In an embodiment, the sensor module may comprise one or more sensors that operate functionally together. For example, the one or more cameras and the one or more sensors within the sensor module are integrated with one another to capture images/videos of road surface conditions and to determine and correlate with signals received from the other sensors.

As used herein, the term “electric vehicle (EV)” refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4, 545 kg gross vehicle weight.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service, of the emergency-reporting vehicle.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as AMQP, MQTT, Zigbee, etc.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation etc. In an embodiment, sensors may be removably or fixedly installed within the vehicle and may be disposed in various arrangements to provide information to the autonomous operation features. The sensors may include cameras, ultrasonic sensors, proximity sensors, accelerometers, gyroscopes, RADAR, LIDAR, etc. Some of the sensors (e.g., radar, LIDAR, or camera units) may actively or passively scan the road surface conditions for the presence of bumps, potholes, slippery surfaces, terrain areas, uneven surfaces, etc.

The term “vehicle” as used herein refers to a thing used for transporting people or goods. Automobiles, cars, trucks, buses, etc., are examples of vehicles.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term “autonomous mode” as used herein refers to a vehicle operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication protocol” as used herein refers to standardized communication between any two systems. An example of a communication protocol is the DSRC protocol. The DSRC protocol uses a specific frequency band (e.g., 5.9 GHz) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein, the term “semi-autonomous vehicle” refers to vehicles that can operate for extended periods with little human input. A semi-autonomous vehicle cannot drive itself at all times but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein, the term “double-fed induction machine (DFIM)” refers to a type of electric motor or generator where both the stator and the rotor windings are connected to external power sources. This configuration allows for control of the machine's speed and torque characteristics, making it highly suitable for applications requiring variable speed operation and improved efficiency. DFIMs are commonly used in applications, such as wind turbines, automobiles, all-wheel drive applications where variable-speed operation is required. The stator of the DFIM comprises a set of three-phase windings that are connected to a fixed-frequency and fixed-voltage AC power supply from the grid. When AC voltage is applied to the stator windings, it produces a rotating magnetic field that induces currents in the rotor. The rotor of the DFIM is equipped with a separate set of windings. These rotor windings are connected to an external AC power supply through slip rings and brushes. This external supply allows for variable-frequency and variable-voltage AC to be applied to the rotor windings. The rotating magnetic field produced by the stator induces currents in the rotor windings. These currents create a magnetic field in the rotor that interacts with the stator's rotating magnetic field. The interaction between the stator and rotor magnetic fields generates torque in the rotor, causing it to rotate. By varying the frequency and voltage of the AC supply to the rotor windings, the speed of the DFIM can be controlled over a wide range. This ability to control the rotor supply frequency and voltage independent of the grid frequency allows the DFIM to operate at different speeds, making it suitable for applications requiring variable-speed operation. During operation, energy is transferred between the stator and rotor through electromagnetic induction. The DFIM can improve overall system efficiency, particularly in applications where variable-speed operation leads to better matching of load requirements and reduces energy losses compared to fixed-speed motors. The working of a double-fed induction machine revolves around the independent control of stator and rotor windings, allowing for variable-speed operation and improved efficiency in a variety of industrial and renewable energy applications.

As used herein, the term “permanent magnet synchronous machine (PMSM)” refers to an electric machine that uses permanent magnets embedded in the rotor to create a constant magnetic field. The permanent magnet synchronous machine (PMSM) operates based on the principles of synchronous rotation, where the rotor and the magnetic field in the stator rotate at the same speed. The stator of a PMSM consists of three-phase windings, typically connected to an AC power supply (such as a variable-frequency drive or an inverter). When AC voltage is applied to the stator windings, it produces a rotating magnetic field in the stator. The permanent magnets in the rotor ensure that the rotor tries to align itself with the rotating magnetic field produced by the stator. This alignment results in synchronous rotation, where the rotor follows the rotating magnetic field at the same speed, hence the name “synchronous machine.” As the rotating magnetic field in the stator interacts with the fixed magnetic field of the rotor, electromagnetic induction occurs. This interaction generates torque in the rotor, causing it to rotate at the synchronous speed. PMSMs are known for their high efficiency and precise control of speed and torque. PMSMs are widely used in various applications requiring precise control and high efficiency, such as in automotive applications.

As used herein, the term “All-wheel drive (AWD)” refers to a drivetrain system in vehicles that distributes power from the engine to all four wheels simultaneously. Unlike front-wheel drive (FWD) and rear-wheel drive (RWD), which primarily power either the front or rear wheels, AWD systems can vary in complexity but generally aim to improve traction and handling in various driving conditions. AWD systems continuously distribute power to all four wheels, adjusting automatically to road conditions. AWD systems typically use a center differential or electronically controlled coupling to manage power distribution between the front and rear axles.

As used herein, the term “first axle” refers to a front axle of the vehicle. The first axle refers to the shaft or assembly that connects the front wheels of a vehicle. The first axle plays a crucial role in the steering and propulsion of the vehicle. The front axle is a critical component in vehicles, responsible for transmitting power to the front wheels in front wheel drive (FWD) or AWD configurations, enabling steering control, and contributing to suspension dynamics for a comfortable and safe driving experience.

As used herein, the term “second axle” refers to a rear axle of the vehicle. The second axle refers to the shaft or assembly that connects the rear wheels of a vehicle. The second axle plays a crucial role in distributing power from the engine to the rear wheels. The rear axle is a critical component in vehicles, responsible for load support and vehicle stability. The rear axle in an AWD vehicle is a critical component that supports the vehicle's load, contributes to stability, and integrates with the suspension system to provide a balanced and controlled ride.

As used herein, the term “axle drive” refers to a system that transfers power from the vehicle's engine or motor to the wheels, allowing the vehicle to move. The axle drive allows for differential wheel speeds for smooth turning. The axle drive ensures that the rotational power is effectively transferred to enable movement.

As used herein, the term “back-to-back converter” refers to an electrical power conversion system that consists of two converters connected in series, with their DC sides linked together. This configuration is used in various applications, including motor drives, renewable energy systems, and power grid interconnections. The back-to-back converter comprises an AC-DC Converter (Rectifier), DC link, and DC-AC Converter (Inverter). The AC-DC converter converts alternating current (AC) from the source to direct current (DC). The AC-DC converter uses power electronics devices such as diodes, thyristors, or transistors (e.g., IGBTs or MOSFETs). The DC link is an intermediate stage that connects the rectifier to the inverter. The DC link usually consists of a DC capacitor that stabilizes the DC voltage and stores energy. The DC-AC converter (Inverter) converts the DC back to AC with the desired frequency, amplitude, and phase. The DC-AC converter uses similar power electronics devices as the rectifier to achieve this conversion. The back-to-back converter works by first converting AC power from the source into DC power through the rectifier stage. The DC power is then stabilized and stored temporarily in the DC link. Finally, the inverter stage converts the DC power back into AC power, which can be controlled in terms of frequency, amplitude, and phase. This process allows for precise control of the output AC power characteristics. The back-to-back converter is used in variable frequency drives (VFDs) to control the speed and torque of AC motors by varying the frequency and voltage of the motor's power supply.

As used herein, the term “stator” refers to a component of an electric motor or generator. It is the stationary part of the machine, in contrast to the rotor, which is the rotating part. The stator's primary role is to produce a magnetic field that interacts with the rotor to create motion (in motors) or generate electricity (in generators). The stator is the non-moving part of an electric motor or generator that houses the windings or coils and is responsible for generating the magnetic field necessary for the operation of the machine. In electric motors, the stator windings create a rotating magnetic field when supplied with AC power. This rotating magnetic field interacts with the rotor, causing it to turn and produce mechanical work.

As used herein, the term “rotor” refers to a component of an electric motor or generator. The rotor is the rotating part of an electric motor or generator that interacts with the stator's magnetic field to produce motion or electricity.

As used herein, the term “terminal” refers to a point of connection for electrical conductors to a device or system. Terminals are essential for establishing electrical connections, allowing the flow of electricity between components. A terminal is a physical connection point in an electrical circuit where wires or other conductors can be attached. The terminal provides a secure and reliable means of connecting electrical components, ensuring proper electrical continuity and mechanical stability.

As used herein, the term “speed” refers to the rate at which an object covers a distance in a specific direction. Speed is a scalar quantity, meaning it only has magnitude (numerical value) and not direction. Speed is calculated by dividing the distance traveled by the time taken to travel that distance.

As used herein, the term “torque” refers to a measure of the rotational force acting on an object around an axis. Mathematically, torque is defined as the product of the force (F) applied to rotate an object and the perpendicular distance (r) from the axis of rotation to the point where the force is applied.

As used herein, the term “battery pack” refers to a collection of individual battery cells or modules electrically connected to each other to achieve a desired voltage, capacity, and performance. The battery pack typically includes additional components such as a battery management system (BMS), connectors, and sometimes cooling systems. The primary purpose of a battery pack is to provide a reliable and compact energy storage solution suitable for specific applications.

As used herein, the term “converter” refers to a device or circuit that converts electrical energy from one form to another. This conversion typically involves altering voltage, current, or frequency to suit specific requirements of electrical systems or devices. The converter may be one of transformer, rectifier, inverter, and DC-to-DC converter.

As used herein, the term “transformer” refers to a device that transfers electrical energy between two or more circuits through electromagnetic induction. The primary function of a transformer is to change the voltage levels between circuits. This can either be stepping up (increasing) or stepping down (decreasing) the voltage. The transformer comprises a primary winding and a secondary winding. When an alternating current (AC) flows through the primary winding, it creates a varying magnetic field in the core. This varying magnetic field induces a voltage in the secondary winding, based on Faraday's law of electromagnetic induction. The transformer may be one of step-up transformer, step-down transformer, and isolation transformer. The step-up transformer increases voltage from primary to secondary winding. The step-down transformer decreases voltage from primary to secondary winding. The isolation transformer provides electrical isolation without changing the voltage significantly.

As used herein, the term “rectifier” refers to an electrical device that converts alternating current (AC), which periodically reverses direction, to direct current (DC), which flows in only one direction. The primary function of a rectifier is to convert AC to DC, which is necessary for devices that require a steady and unidirectional current. The rectifier may be one of half-wave rectifier, and full-wave rectifier. The half-wave rectifier uses a single diode to convert only one half-cycle of the AC input into DC. This results in a pulsating DC output. The full-wave rectifier uses multiple diodes to convert both half-cycles of the AC input into DC.

As used herein, the term “DC-to-DC converter” refers to a device that converts a source of direct current (DC) from one voltage level to another. These converters are widely used in various applications where the power supply needs to be regulated and optimized for different components within a system. The primary function of a DC-to-DC converter is to efficiently change the DC voltage level to match the requirements of different parts of an electronic system, ensuring proper operation and power efficiency.

As used herein, the term “inverter” refers to an electrical device or circuitry that converts direct current (DC) to alternating current (AC). This conversion process enables the use of DC power sources, such as batteries or solar panels, to power devices or systems that require AC electricity.

As used herein, the term “rotor field angle” refers to an angle between the magnetic field produced by the rotor winding and the magnetic field produced by the stator winding. The rotor field angle is crucial for determining the operation and performance of the machine, particularly in terms of torque production and power factor control.

As used herein, the term “independent of” refers to describe a situation where one thing is not affected or influenced by another. In this present disclosure, the first speed and the first torque obtained on the first axle drive is not affected or influenced by the second speed and the second torque obtained on the second axle drive.

As used herein, the term “smart cell” refers to a device that comprises a battery pack and an electronic circuit. The “smart cell” is capable of providing a direct current directly from the battery pack. The smart cell further comprises inverters that convert the DC to AC based on a message received from a sensor module. The smart cell is also configured to provide the AC at the required voltage level.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem: In conventional battery electric vehicles (BEV), AWD setups always require two inverters, one for each axle to have independent speed and torque for both axles. The two inverters demand high cost, space, and weight problems. Further the two inverters demand excellence in designing and implementation which requires more labor. The two inverters also consume additional charges to operate which incurs additional cost of charging. The involvement of two inverters in the conventional battery electric vehicles incurs additional electronic components. As a general rule, simpler designs will be more reliable. Thus, there should be a push for simplicity throughout all phases of the design process. The necessity of all parts should be questioned, and design simplifications should be employed where available. This can be achieved through circuit design simplifications or by simply using fewer parts. Accordingly, there remains a market gap in the industry in which a customer need is currently unfulfilled or underserved by existing services or products.

Business Solution: The present disclosure provides a cost-effective solution which uses a Double-Fed-Induction Machine (DFIM) on one of the axle drives which in turn enables the battery electric vehicles to operate the all-wheel drive using only one inverter. The present solution further requires less space for implementation since it involves only one inverter. The present solution drastically reduces the weight, cost and space in the manufacturing of battery electric vehicles. In addition, this cost-effective solution improves mileage efficiency.

Technical problem: In conventional BEV, inverter is required to convert DC output from battery to AC output for the input to electric machines. Hence, the conventional AWD setups always require two inverters, one for each axle to have independent speed and torque for both axles. The two inverters demand high cost, space, and weight problems. The need of two inverters in conventional BEV requires two separate power transmission lines which in turn creates complexity in design and placement.

Technical Solution: The present disclosure discloses the system using a Double-Fed-Induction Machine (DFIM) on one of the axle drives to operate the Battery Electric Vehicles in All-Wheel-Drive applications. In DFIM, the load angle can be controlled via two converters which helps to have independent control of speed and torque of both front axle drive and rear axle drive in the vehicles. The present solution achieves the similar independent speed and torque on front and rear axle drives with only one inverter by using the DFIM on one of the axle drives. In this embodiment, the inverter is adapted to convert the DC (from battery pack) to AC in order to provide inputs to the electric machines (DFIM and the first electric machine) on the front axle drive and the rear axle drive. In another embodiment, the present disclosure discloses the system that operates without any inverter when the battery pack is replaced with a smart cell. The smart cell directly provides the required AC as inputs to the DFIM and first electric machine.

Technical Result: The present disclosure discloses the system that eliminates the need for the two inverters in the battery electric vehicles which in turn reduces the cost, space and weight in the manufacturing of the Battery Electric Vehicles. The use of a DFIM on one of the axle drives, and the electric machine (e.g., permanent magnet synchronous motor) on the other axle drive achieves independent speed and torque on the front axle drive and the rear axle drive. In this embodiment, the system uses only one inverter in common for the front axle drive and the rear axle drive when the power supply comprises the battery pack. One inverter is used in order to convert the DC (from battery pack) to AC to provide AC to the DFIM and the first electric machine. In another embodiment, the system uses the smart cell instead of the battery pack. In this embodiment, the system operates without the inverter as the smart cell directly provides the AC output as the inputs to the electric machines (DFIM and the first electric machine) in AWD setup. The smart cell eliminates the need for the inverters as there is no need for conversion of DC to AC. The present solution also provides appropriate power via the controller to the front axle drive and the rear axle drive based on a message received from the sensor module. The sensor module detects the road surface conditions and communicates with messages to the controller.

How Technical Solution is a Technological Advancement: The technical solution enables the battery electric vehicles to operate with a single inverter, or without an inverter, in AWD setup. The elimination of the inverters reduces the complexity in manufacturing of the battery electric vehicles in terms of design, placement, cost, weight, and space. The elimination of the inverters in the AWD set up further provides a technical advancement in creating a simpler circuit design. The simpler circuit design in turn increases the reliability of the functioning of the AWD setup. The present solution further provides a technical advancement in providing appropriate power to the electric machines on the front axle drive and the rear axle drive based on a message received from sensor module

Technical Details Specific to the Technical Solution:

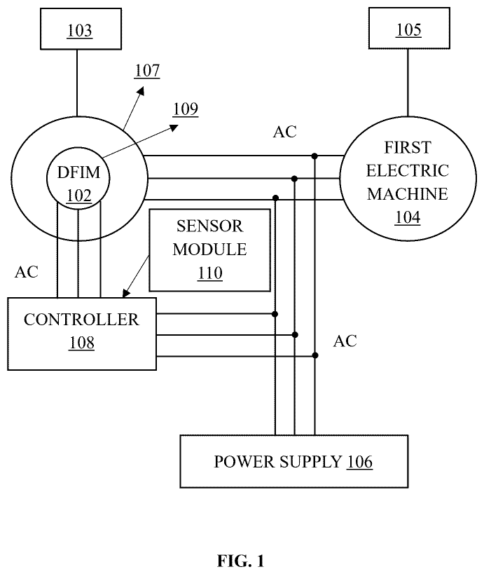

In an aspect, a system is described. As an example, FIG. 1 illustrates a power system having a simpler circuit design for all-wheel drive (AWD) application, according to one or more embodiments. The system comprises: a double-fed induction machine (DFIM) 102 coupled to a first axle drive 103; a first electric machine 104 coupled to a second axle drive 105; a power supply 106 that supplies a first power to the first electric machine 104; and a controller 108. In this embodiment, the power supply 106 is a smart cell. The smart cell provides a three-phase alternating current (AC) power as the first power. The smart cell comprises a battery pack as an energy source and an integrated electronic circuit. The smart cell is capable of providing a direct current directly from the battery pack. The electronic circuit integrated within the smart cell further comprises inverters that convert the DC to AC. The smart cell is configured to provide the AC to the electric machine at the required voltage level. The electric machine referred to in this embodiment includes DFIM 102 and the first electric machine 104. The first electric machine 104 may be a permanent magnet synchronous machine (PMSM).

The power supply 106 provides the first power to a stator terminal 107 of the double-fed induction machine (DFIM) 102. The system further comprises a sensor module 110. The sensor module 110 may be positioned in the front portion of the vehicle facing the road for monitoring the road surface conditions. The controller 108 is configured to receive the first power from the power supply 106 and convert the first power to a second power through a back-to-back converter based on a message received from the sensor module 110. The sensor module 110 comprises at least one of cameras, proximity sensors, ultrasonic sensors, radar sensor, light detection and ranging (LIDAR) sensors, temperature sensors, etc. The sensor module 110 senses the road surface conditions and determines at least one of bumps, potholes, slippery surfaces, terrain areas, uneven surfaces, etc. The sensor module 110 may also monitor environmental weather conditions, ambient temperature, etc. The sensor module 110 then communicates a message to the controller 108. The controller 108 is configured to convert the first power to the second power based on a message received from the sensor module 110. The controller 108 is then configured to supply the second power to a rotor terminal 109 of the double-fed induction machine (DFIM) 102. The controller may comprise the back-to-back converter.

The back-to-back converter refers to an electrical power conversion system that consists of two converters connected in series, with their DC sides linked together. The back-to-back converter comprises an AC-DC Converter (Rectifier), DC link, and DC-AC Converter (Inverter). The AC-DC converter converts alternating current (AC) from the power supply 106 to direct current (DC). The AC-DC converter uses power electronics devices such as diodes, thyristors, or transistors (e.g., IGBTs or MOSFETs). The DC link is an intermediate stage that connects the rectifier to the inverter. The DC link usually consists of a DC capacitor that stabilizes the DC voltage and stores energy. The DC-AC converter (Inverter) converts the DC back to AC with the desired frequency, amplitude, and phase. The DC-AC converter uses similar power electronics devices as the rectifier to achieve this conversion. The back-to-back converter works by first converting AC power from the power supply 106 into DC power through the rectifier. The DC power is then stabilized and stored temporarily in the DC link. Finally, the inverter converts the DC power back into AC power, which can be controlled in terms of frequency, amplitude, and phase. The back-to-back converter thus allows for precise control of the output AC power characteristics. The back-to-back converter is used in variable frequency drives (VFDs) to control the speed and torque of electric motors by varying the frequency and voltage of the motor's power supply.

The power supply 106, supplying the first power to the first electric machine 104, is adapted to obtain a first speed and a first torque from the first electric machine 104 on the second axle drive 105. The power supply 106 and the controller 108, supplying the first power and the second power to the stator terminal 107 and the rotor terminal 109 respectively of the double-fed induction machine (DFIM) 102, is adapted to obtain a second speed and a second torque from the double-fed induction machine (DFIM) 102 on the first axle drive 103. The controller 108, supplying the second power to the rotor terminal of the double-fed induction machine (DFIM) 102, is adapted to vary a rotor field angle of the double-fed induction machine (DFIM). In an embodiment, the rotor field angle of the double-fed induction machine (DFIM) 102 is varied to obtain a second speed and a second torque on the first axle drive 103 independent of a first speed and a first torque on the second axle drive 105.

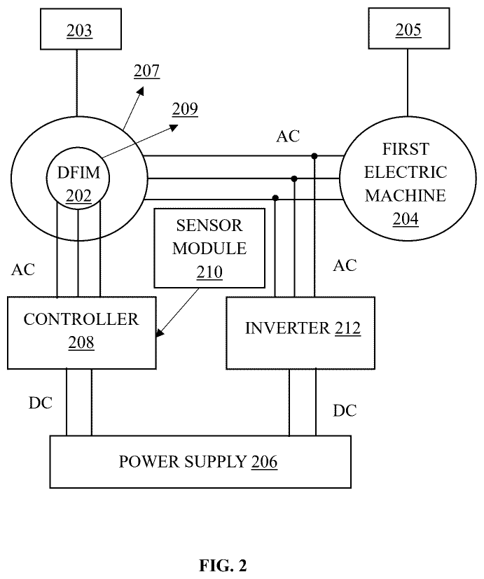

In another aspect, a system is described. As an example, FIG. 2 illustrates a power system having a simpler circuit design for all-wheel drive (AWD) application, according to one or more embodiments. The system comprises: a double-fed induction machine (DFIM) 202 coupled to a first axle drive 203; a first electric machine 204 coupled to a second axle drive 205; a power supply 206 that supplies a first power to the first electric machine 204; and a controller 208. In this embodiment, the power supply 106 is a battery pack. The battery pack provides a direct current.

The system further comprises an inverter 212 electrically coupled to the power supply 206. The inverter 212 is adapted to convert the direct current (DC) received from the power supply 206 to a three-phase alternating current (AC) power as the first power to provide as inputs to the electric machines (DFIM 202 and the first electric machine 204). In an embodiment, the first electric machine 204 may be a permanent magnet synchronous machine (PMSM). The inverter 212 provides the three-phase alternating current (AC) as the first power to a stator terminal 207 of the double-fed induction machine (DFIM) 102.

The system further comprises a sensor module 210. The sensor module 210 may be positioned in the front portion of the vehicle facing the road for monitoring the road surface conditions. The controller 208 is configured to receive the direct current (DC) from the power supply 206 and convert the direct current (DC) to a second power based on a message received from the sensor module 210. The second power may be a three-phase alternating current. In an embodiment, the rotor terminal 209 of the double-fed induction machine 202 (DFIM) receives the second power and the stator terminal 207 of the double-fed induction machine (DFIM) 202 receives the first power. In an embodiment, the second power fed to the rotor terminal of the DFIM 202 is different from the first power fed to the stator terminal of the DFIM 202.

The sensor module 210 comprises at least one of cameras, proximity sensors, ultrasonic sensors, radar sensor, light detection and ranging (LIDAR) sensors, temperature sensors, etc. The sensor module 110 senses the road surface conditions and determines at least one of bumps, potholes, slippery surfaces, terrain areas, uneven surfaces, etc. The sensor module 210 may also monitor environmental weather conditions, ambient temperature, etc. The sensor module 210 then communicates a message to the controller 208. The controller 208 is configured to convert the direct current (DC) to the second power based on a message received from the sensor module 210. The controller 208 is then configured to supply the second power to the rotor terminal 209 of the double-fed induction machine (DFIM) 202.

In one embodiment, the controller 208 comprises a first component and a second component. The first component functions as a modulator that converts the direct current (DC) into a first three-phase alternating current (AC) power. The second component functions as a demodulator that converts the first three-phase alternating current (AC) power into a second direct current (DC) and further converts the second direct current (DC) into a second three-phase alternating current (AC) power. The second component provides the second three-phase alternating current (AC) power as the second power to the rotor terminal 209 of the double-fed induction machine (DFIM) 202. The first component provides the first three-phase alternating current (AC) power as the first power to the stator terminal 207 of the double-fed induction machine (DFIM) 202.

The second power to the rotor terminal 209 of the double-fed induction machine (DFIM) 202 is adapted to vary a rotor field angle of the double-fed induction machine (DFIM) 202. The rotor field angle of the double-fed induction machine (DFIM) 202 is varied to obtain a second speed and a second torque on the first axle drive independent of a first speed and a first torque on the second axle drive.

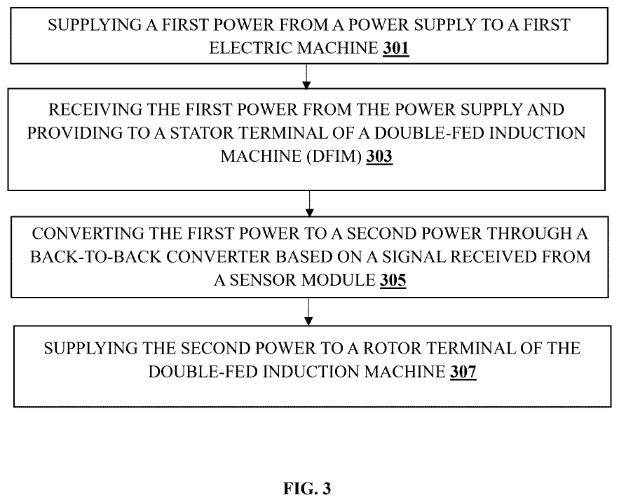

In another aspect, a method is described. As an example, FIG. 3 illustrates a method for all-wheel drive (AWD) application, according to one or more embodiments. The method comprises: supplying a first power from a power supply to a first electric machine (at step 301); receiving the first power from the power supply and providing to a stator terminal of a double-fed induction machine (DFIM) (at step 303); converting the first power to a second power through a back-to-back converter based on a message received from a sensor module (at step 305); and supplying the second power to a rotor terminal of the double-fed induction machine (DFIM) (at step 307). The first electric machine may be a permanent magnet synchronous machine (PMSM).

In one embodiment, the power supply comprises a smart cell that provides a three-phase alternating current (AC) power as the first power. In an embodiment, supplying the first power to the first electric machine is adapted to obtain a first speed and a first torque from the first electric machine on a second axle drive. In an embodiment, supplying the first power and the second power to the stator terminal and the rotor terminal respectively of the double-fed induction machine (DFIM) is adapted to obtain a second speed and a second torque from the double-fed induction machine (DFIM) on a first axle drive.

In another embodiment, the power supply is a battery pack that provides a direct current (DC). The method further comprises: converting, via an inverter, a direct current to a three-phase alternating current (AC) power as the first power. The method further comprises: converting, by a first component, the direct current (DC) into a first three-phase alternating current (AC) power. The method further comprises: converting, by a second component, the first three-phase alternating current (AC) power into a second direct current (DC) and further converting the second direct current (DC) into a second three-phase alternating current (AC) power. The method further comprises: providing, by the second component, the second three-phase alternating current (AC) power as the second power to the rotor terminal of the double-fed induction machine (DFIM). The method further comprises: providing, by the first component, the first three-phase alternating current (AC) power as the first power to the stator terminal of the double-fed induction machine (DFIM).

In an embodiment, the method further comprises: varying a rotor field angle of the double-fed induction machine (DFIM) based on the second power fed to the rotor terminal of the double-fed induction machine (DFIM). The method further comprises: obtaining a second speed and a second torque on a first axle drive independent of a first speed and a first torque on a second axle drive in accordance with varying the rotor field angle of the double-fed induction machine (DFIM).

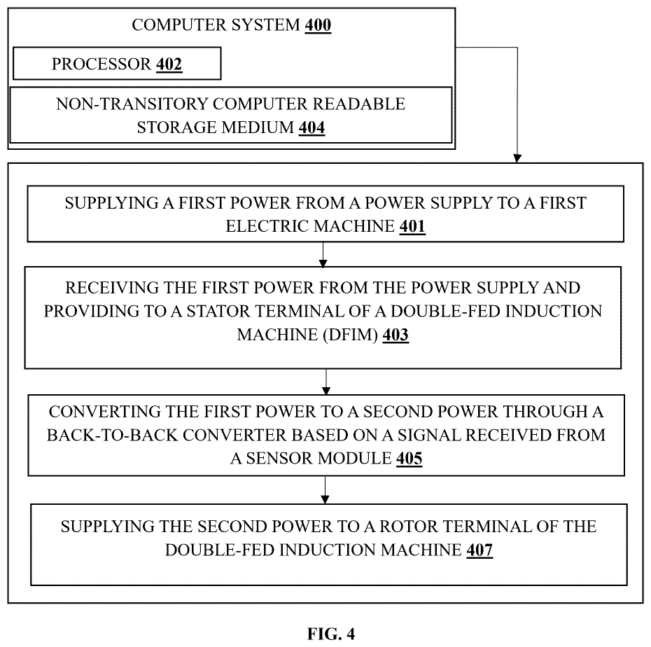

In another aspect, a non-transitory computer readable storage medium is described. As an example, FIG. 4 illustrates a non-transitory computer readable storage medium 404, according to one or more embodiments. The non-transitory computer readable storage medium 404 comprises a sequence of instructions, which when executed by a processor 402 causes: supplying a first power from a power supply to a first electric machine (at step 401); receiving the first power from the power supply and providing to a stator terminal of a double-fed induction machine (DFIM) (at step 403); converting the first power to a second power through a back-to-back converter based on a message received from a sensor module (at step 405); and supplying the second power to a rotor terminal of the double-fed induction machine (DFIM) (at step 407). In an embodiment, the first electric machine is a permanent magnet synchronous machine (PMSM). The computer system 400 may comprise the non-transitory computer readable storage medium 404 and the processor 402.

In an embodiment, the power supply comprises a smart cell that provides a three-phase alternating current (AC) power as the first power. In an embodiment, supplying the first power to the first electric machine is adapted to obtain a first speed and a first torque from the first electric machine on a second axle drive. In an embodiment, supplying the first power and the second power to the stator terminal and the rotor terminal respectively of the double-fed induction machine (DFIM) is adapted to obtain a second speed and a second torque from the double-fed induction machine (DFIM) on a first axle drive.

In another embodiment, the power supply is a battery pack that provides a direct current (DC). In this embodiment, the non-transitory computer readable storage medium 404 further causes: converting, via an inverter, a direct current to a three-phase alternating current (AC) power as the first power. In this embodiment, the non-transitory computer readable storage medium 404 further causes: converting, by a first component, the direct current (DC) into a first three-phase alternating current (AC) power. In this embodiment, the non-transitory computer readable storage medium 404 further causes: converting, by a second component, the first three-phase alternating current (AC) power into a second direct current (DC) and further converting the second direct current (DC) into a second three-phase alternating current (AC) power. In this embodiment, the non-transitory computer readable storage medium 404 further causes: providing, by the second component, the second three-phase alternating current (AC) power as the second power to the rotor terminal of the double-fed induction machine (DFIM). In this embodiment, the non-transitory computer readable storage medium 404 further causes: providing, by the first component, the first three-phase alternating current (AC) power as the first power to the stator terminal of the double-fed induction machine (DFIM).

In an embodiment, the non-transitory computer readable storage medium 404 further causes: varying a rotor field angle of the double-fed induction machine (DFIM) based on the second power fed to the rotor terminal of the double-fed induction machine (DFIM). The non-transitory computer readable storage medium 404 further causes: obtaining a second speed and a second torque on a first axle drive independent of a first speed and a first torque on a second axle drive in accordance with varying the rotor field angle of the double-fed induction machine (DFIM).

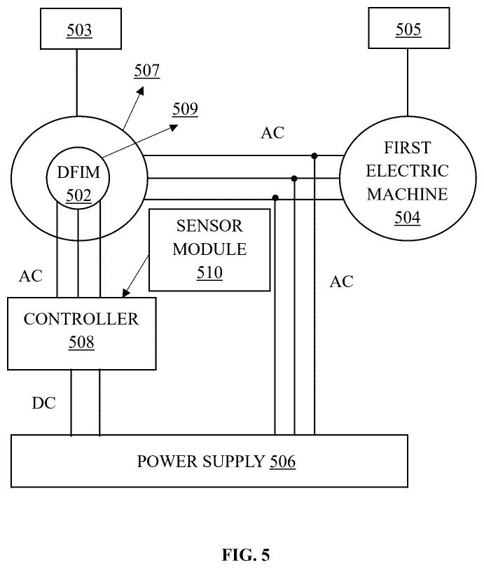

In another aspect, a system is described. As an example, FIG. 5 illustrates a power system having a simpler circuit design for all-wheel drive (AWD) application, according to one or more embodiments. The system comprises: a double-fed induction machine (DFIM) 502 coupled to a first axle drive 503; a first electric machine 504 coupled to a second axle drive 505; a power supply 506 that supplies a first power (e.g., AC power) to the first electric machine 504; and a controller 508. The controller 508 is configured to: receive the first power from the power supply 506 and provides the first power to a stator terminal 507 of the double-fed induction machine (DFIM); receive a direct current (DC) from the power supply; convert the direct current (DC) to a second power through a converter; and supply the second power to a rotor terminal of the double-fed induction machine (DFIM). The first electric machine may be a permanent magnet synchronous machine (PMSM).

In an embodiment, supplying the first power to the first electric machine is adapted to obtain a first speed and a first torque from the first electric machine on the second axle drive. In this embodiment, supplying the first power and the second power to the stator terminal and the rotor terminal respectively of the double-fed induction machine (DFIM) is adapted to obtain a second speed and a second torque from the double-fed induction machine (DFIM) on the first axle drive. In this embodiment, the rotor terminal of the double-fed induction machine (DFIM) receives the second power. In this embodiment, the stator terminal of the double-fed induction machine (DFIM) receives the first power.

In one embodiment, the power supply 506 comprises a smart cell that provides a three-phase alternating current (AC) power as the first power.

In this embodiment, the power supply 506 is a battery pack that provides the direct current (DC). The controller 508 is configured to convert the first power to the second power. In an embodiment, the controller 508 comprises a first component and a second component. The first component functions as a modulator that converts the direct current (DC) into a first three-phase alternating current (AC) power. The second component functions as a demodulator that converts the first three-phase alternating current (AC) power into a second direct current (DC) and further converts the second direct current (DC) into a second three-phase alternating current (AC) power. The second component provides the second three-phase alternating current (AC) power as the second power to the rotor terminal of the double-fed induction machine (DFIM) 502. The first component provides the first three-phase alternating current (AC) power as the first power to the stator terminal of the double-fed induction machine (DFIM) 502.

In an embodiment, the second power is fed to the rotor terminal 509 of the double-fed induction machine (DFIM) 502 to vary a rotor field angle of the double-fed induction machine (DFIM) 502. In an embodiment, varying the rotor field angle of the double-fed induction machine (DFIM) 502 is adapted to obtain a second speed and a second torque on the first axle drive 503 independent of a first speed and a first torque on the second axle drive 505.

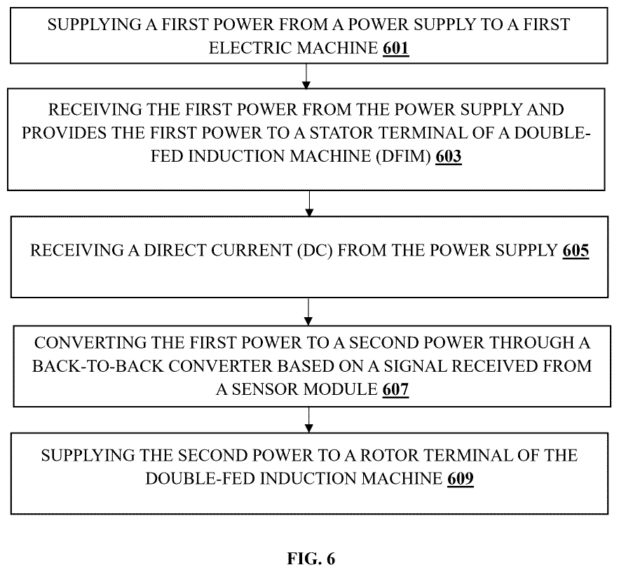

In another aspect, a method is described. As an example, FIG. 6 illustrates a method, according to one or more embodiments. The method comprises: supplying a first power from a power supply to a first electric machine (at step 601); receiving the first power from the power supply and provides the first power to a stator terminal of a double-fed induction machine (DFIM) (at step 603); receiving a direct current (DC) from the power supply (at step 605); converting the direct current (DC) to a second power through a converter (at step 607); and supplying the second power to a rotor terminal of the double-fed induction machine (DFIM) (at step 609). The first electric machine may be a permanent magnet synchronous machine (PMSM).

In an embodiment, supplying the first power to the first electric machine is adapted to obtain a first speed and a first torque from the first electric machine on a second axle drive. In this embodiment, supplying the first power and the second power to the stator terminal and the rotor terminal respectively of the double-fed induction machine (DFIM) is adapted to obtain a second speed and a second torque from the double-fed induction machine (DFIM) on a first axle drive.

In one embodiment, the power supply comprises a smart cell that provides a three-phase alternating current (AC) power as the first power.

In another embodiment, the power supply is a battery pack that provides the direct current (DC). The method further comprises: converting, via an inverter, the direct current to a three-phase alternating current (AC) power as the first power. The converter comprises a first component and a second component. The method further comprises: converting, by a first component, the direct current (DC) into a first three-phase alternating current (AC) power; and converting, by a second component, the first three-phase alternating current (AC) power into a second direct current (DC) and further converting the second direct current (DC) into a second three-phase alternating current (AC) power. The method further comprises: providing, by the second component, the second three-phase alternating current (AC) power as the second power to the rotor terminal of the double-fed induction machine (DFIM). The method further comprises: providing, by the first component, the first three-phase alternating current (AC) power as the first power to the stator terminal of the double-fed induction machine (DFIM).

In an embodiment, the method further comprises: varying a rotor field angle of the double-fed induction machine (DFIM) based on the second power fed to the rotor terminal of the double-fed induction machine (DFIM). The method further comprises: obtaining a second speed and a second torque on a first axle drive, independent of a first speed and a first torque on a second axle drive, in accordance with varying the rotor field angle of the double-fed induction machine (DFIM).

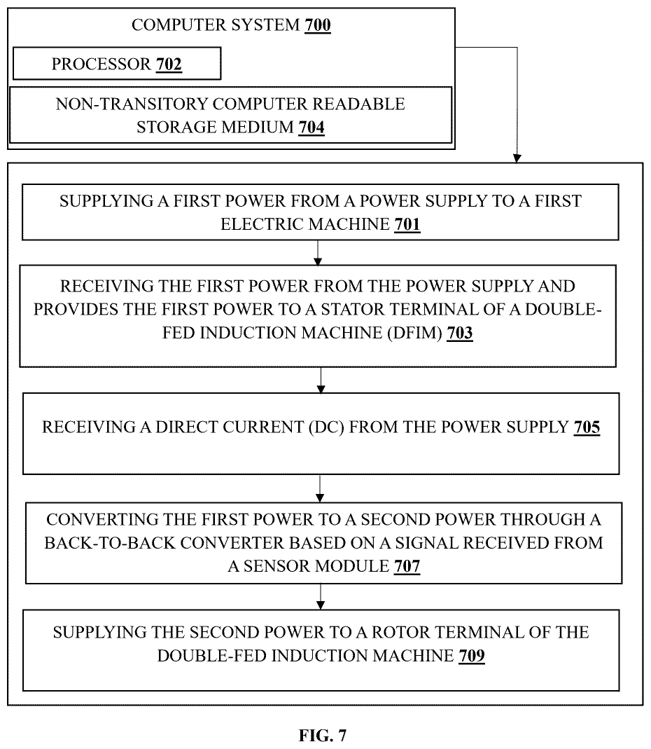

In another aspect, a non-transitory computer readable storage medium is described. As an example, FIG. 7 illustrates a non-transitory computer readable storage medium 704, according to one or more embodiments. The non-transitory computer readable storage medium 704 comprising a sequence of instructions, which when executed by a processor 702 causes: supplying a first power from a power supply to a first electric machine (at step 701); receiving the first power from the power supply and provides the first power to a stator terminal of a double-fed induction machine (DFIM) (at step 703); receiving a direct current (DC) from the power supply (at step 705); converting the direct current (DC) to a second power through a converter (at step 707); and supplying the second power to a rotor terminal of the double-fed induction machine (DFIM) (at step 709). The first electric machine may be a permanent magnet synchronous machine (PMSM). The computer system 700 may comprise the non-transitory computer readable storage medium 704 and the processor 702.

In an embodiment, supplying the first power to the first electric machine is adapted to obtain a first speed and a first torque from the first electric machine on a second axle drive. In this embodiment, supplying the first power and the second power to the stator terminal and the rotor terminal respectively of the double-fed induction machine (DFIM) is adapted to obtain a second speed and a second torque from the double-fed induction machine (DFIM) on a first axle drive.

In an embodiment, the power supply comprises a smart cell that provides a three-phase alternating current (AC) power as the first power.

In one embodiment, the power supply is a battery pack that provides the direct current (DC). The non-transitory computer readable storage medium further causes: converting, via an inverter, the direct current to a three-phase alternating current (AC) power as the first power. The converter comprises a first component and a second component. The non-transitory computer readable storage medium further causes: converting, by a first component, the direct current (DC) into a first three-phase alternating current (AC) power. The non-transitory computer readable storage medium further causes: converting, by a second component, the first three-phase alternating current (AC) power into a second direct current (DC) and further converting the second direct current (DC) into a second three-phase alternating current (AC) power. The non-transitory computer readable storage medium further causes: providing, by the second component, the second three-phase alternating current (AC) power as the second power to the rotor terminal of the double-fed induction machine (DFIM). The non-transitory computer readable storage medium further causes: providing, by the first component, the first three-phase alternating current (AC) power as the first power to the stator terminal of the double-fed induction machine (DFIM).

In an embodiment, the non-transitory computer readable storage medium further causes: varying a rotor field angle of the double-fed induction machine (DFIM) based on the second power fed to the rotor terminal of the double-fed induction machine (DFIM). In this embodiment, the non-transitory computer readable storage medium further causes: obtaining a second speed and a second torque on a first axle drive, independent of a first speed and a first torque on a second axle drive, in accordance with varying the rotor field angle of the double-fed induction machine (DFIM).

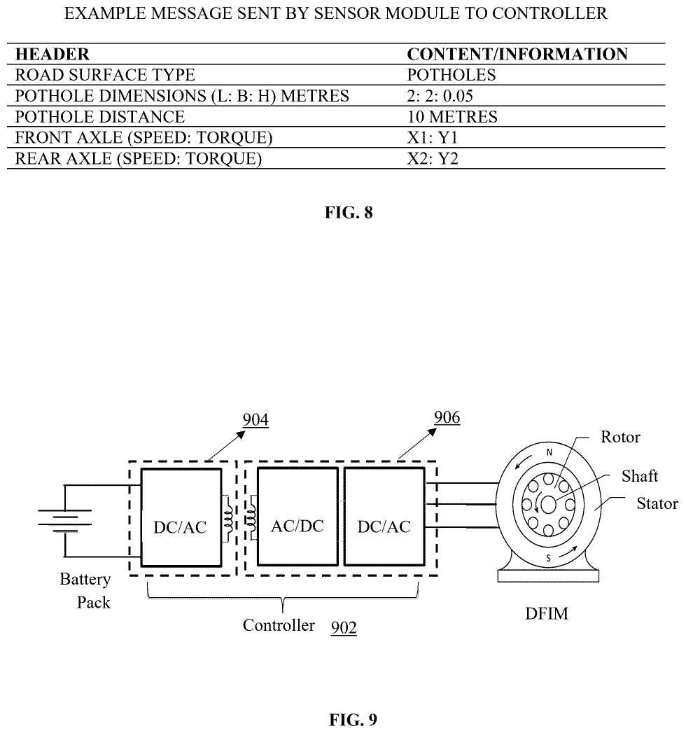

As an example, FIG. 8 illustrates a message sent by the sensor module to the controller, according to one or more embodiments. The sensor module is positioned in the front area of the vehicle facing the road to determine the road surface conditions. Based on the road surface conditions, the first axle drive and the second axle drive require independent speed and torque to safely and efficiently cross the road surface conditions. The sensor module monitors the road and determines the road surface conditions such as road bumps, terrain areas, potholes, etc. The sensor module determines at least the road surface condition type, the distance between the vehicle and the road surface condition (e.g., potholes), dimensions of the road surface condition (e.g., potholes), required front axle speed and torque, required rear axle speed and torque, etc. The controller upon receiving the message from the sensor module provides required power to the first axle drive and the second axle drive which in turn achieves the independent speed and independent torque on both the first axle drive and the second axle drive.

As an example, FIG. 9 illustrates a schematic diagram of a controller, according to one or more embodiments. The controller 902 receives the power from the power supply. The power supply herein is a battery pack. The controller 902 comprises a first component 904 and a second component 906. The first component 904 may be a first converter. The second component 906 may be a second converter.

The first component 904 functions as a modulator that converts the direct current (DC) from the power supply into a first three-phase alternating current (AC) power. The second component 906 functions as a demodulator that converts the first three-phase alternating current (AC) power into a second direct current (DC) and further converts the second direct current (DC) into a second three-phase alternating current (AC) power. The second component 906 provides the second three-phase alternating current (AC) power as the second power to the rotor terminal of the double-fed induction machine (DFIM). The first component may provide the first three-phase alternating current (AC) power as the first power to the stator terminal of the double-fed induction machine (DFIM).

In an embodiment, the controller supplying the first power to the stator terminal and supplying the second power to the rotor terminal obtains a varying rotor field angle of the double-fed induction machine (DFIM). In an embodiment, the second power varies (lags/leads) 10 to 15 percent when compared to the first power. The difference in the first power and the second power creates a variation in the rotor field angle. The varying rotor field angle obtains a second speed and a second torque on a first axle drive independent of a first speed and a first torque on a second axle drive. The variation in the rotor field angle on the first axle drive creates a difference in speed and torque on the first axle drive when compared to the speed and torque on the second axle drive.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings, such terms are intended to be inclusive in a manner similar to the term “comprising”, as “comprising” is interpreted when employed as a transitional word in a claim.

Other specific forms may embody the present invention without departing from its spirit or characteristics. The described embodiments are in all respects illustrative and not restrictive. Therefore, the appended claims, rather than the description herein, indicate the scope of the invention. All variations which come within the meaning and range of equivalency of the claims are within their scope.

1.-87. (canceled)

88. A system comprising:
a doubly fed induction machine (DFIM) coupled to a first axle drive;
a first machine coupled to a second axle drive;
a power supply that supplies a first power to the first machine; and
a controller that is configured to
receive the first power from the power supply and provides to a stator terminal of the doubly fed induction machine (DFIM);
convert the first power to a second power through a back-to-back converter based on a signal received from a sensor module; and
supply the second power to a rotor terminal of the doubly fed induction machine (DFIM).

89. The system of claim 88, wherein the first machine is a permanent magnet synchronous machine (PMSM).

90. The system of claim 88, wherein the power supply comprises a smart cell that provides a three-phase alternating current (AC) power as the first power.

91. The system of claim 88, wherein the power supply is a battery pack that provides a direct current (DC).

92. The system of claim 91, wherein the system further comprises an inverter electrically coupled to the power supply that converts the direct current to a three-phase alternating current (AC) power as the first power.

93. The system of claim 91, wherein the controller comprises a first component and a second component,
the first component functions as a modulator that converts the direct current (DC) into a first three-phase alternating current (AC) power; and
the second component functions as a demodulator that converts the first three-phase alternating current (AC) power into a second direct current (DC) and further converts the second direct current (DC) into a second three-phase alternating current (AC) power.

94. The system of claim 93, wherein the second component provides the second three-phase alternating current (AC) power as the second power to the rotor terminal of the doubly fed induction machine (DFIM).

95. The system of claim 93, wherein the first component provides the first three-phase alternating current (AC) power as the first power to the stator terminal of the doubly fed induction machine (DFIM).

96. The system of claim 94, wherein the second power to the rotor terminal of the doubly fed induction machine (DFIM) is adapted to vary a rotor field angle of the doubly fed induction machine (DFIM).

97. The system of claim 96, wherein the rotor field angle of the doubly fed induction machine (DFIM) is varied to obtain a second speed and a second torque on the first axle drive independent of a first speed and a first torque on the second axle drive.

98. A method comprising:
supplying a first power from a power supply to a first machine;
receiving the first power from the power supply and providing to a stator terminal of a doubly fed induction machine (DFIM);
converting the first power to a second power through a back-to-back converter based on a signal received from a sensor module; and
supplying the second power to a rotor terminal of the doubly fed induction machine (DFIM).

99. The method of claim 98, wherein supplying the first power to the first machine is adapted to obtain a first speed and a first torque from the first machine on a second axle drive.

100. The method of claim 98, wherein supplying the first power and the second power to the stator terminal and the rotor terminal respectively of the doubly fed induction machine (DFIM) is adapted to obtain a second speed and a second torque from the doubly fed induction machine (DFIM) on a first axle drive.

101. The method of claim 98, further comprising: varying a rotor field angle of the doubly fed induction machine (DFIM) based on the second power fed to the rotor terminal of the doubly fed induction machine (DFIM).

102. The method of claim 101, further comprising: obtaining a second speed and a second torque on a first axle drive independent of a first speed and a first torque on a second axle drive in accordance with varying the rotor field angle of the doubly fed induction machine (DFIM).

103. A non-transitory computer readable storage medium comprising a sequence of instructions, which when executed by a processor causes:
supplying a first power from a power supply to a first machine;
receiving the first power from the power supply and providing to a stator terminal of a doubly fed induction machine (DFIM);
converting the first power to a second power through a back-to-back converter based on a signal received from a sensor module; and
supplying the second power to a rotor terminal of the doubly fed induction machine (DFIM).

104. The non-transitory computer readable storage medium of claim 103, wherein supplying the first power to the first machine is adapted to obtain a first speed and a first torque from the first machine on a second axle drive.

105. The non-transitory computer readable storage medium of claim 103, wherein supplying the first power and the second power to the stator terminal and the rotor terminal respectively of the doubly fed induction machine (DFIM) is adapted to obtain a second speed and a second torque from the doubly fed induction machine (DFIM) on a first axle drive.

106. The non-transitory computer readable storage medium of claim 103, further causes:
varying a rotor field angle of the doubly fed induction machine (DFIM) based on the second power fed to the rotor terminal of the doubly fed induction machine (DFIM).

107. The non-transitory computer readable storage medium of claim 106, further causes:
obtaining a second speed and a second torque on a first axle drive independent of a first speed and a first torque on a second axle drive in accordance with varying the rotor field angle of the doubly fed induction machine (DFIM).
